(19) United States
(12) Patent Application Publication
(10) Pub. No.: US 2021/0027255 A1
(43) Pub. Date: Jan. 28, 2021

(54) SYSTEMS AND METHODS FOR OPERATING AN INTERACTIVE REPAIR FACILITY INCLUDING A PRICE MATRIX FUNCTION

(71) Applicant: Shop-Ware, Inc., San Francisco, CA (US)

(72) Inventors: Carolyn Coquillette, San Francisco, CA (US); Chip Keen, Forks, WA (US); Tyler Olmstead, San Diego, CA (US); Sue Anna Yeh, Los Angeles, CA (US)

(21) Appl. No.: 17/068,633

(22) Filed: Oct. 12, 2020

Related U.S. Application Data
(63) Continuation of application No. 15/862,536, filed on Jan. 4, 2018.
(60) Provisional application No. 62/466,226, filed on Mar. 2, 2017.

(51) Int. Cl. G06Q 10/00; G06Q 10/08; G06Q 30/02; G06Q 10/06

(52) U.S. Cl. CPC G06Q 10/20; G06Q 10/06311; G06Q 30/0206; G06Q 10/08

(57) ABSTRACT

In various embodiments, a system includes a computer system or cloud interface located in a repair facility and a network in communication with the computer system or cloud interface, and the Internet. In addition, the system includes a database for storing historical task-related data and parts inventory data. The system learns from the repair facility's historical parts sales data, including: parts quantities sold; parts costs when sold; prices charged for the parts; and profit earned on the parts sold. Furthermore, the system calculates an optimal price to charge for one or more parts at the time of estimate or the time of sale, using a price matrix function to achieve a target gross profit.

### CROSS-REFERENCE TO RELATED APPLICATIONS

This is a continuation application of co-pending U.S. patent application Ser. No. 15/862,536 filed Jan. 4, 2018, entitled “Systems and Methods for Operating an Interactive Repair Facility,” by Carolyn Coquillette et al., which claims the benefit of U.S. Provisional Patent Application No. 62/466,226 filed Mar. 2, 2017, entitled “Systems and Processes for Operating a User-Interactive and Customer-Interactive Repair Facility,” by Carolyn Coquillette et al., which are hereby incorporated by reference.

This application is related to U.S. patent application Ser. No. ______ entitled “Systems and Methods for Operating an Interactive Repair Facility Including a Service Builder Function,” by Carolyn Coquillette et al., Attorney Docket No. SHOP-0001-06C01US, filed Oct. 12, 2020.

This application is related to U.S. patent application Ser. No. ______ entitled “Systems and Methods for Operating an Interactive Repair Facility Including Automatic Parts Tracking and Ordering,” by Carolyn Coquillette et al., Attorney Docket No. SHOP-0001-07C01US, filed Oct. 12, 2020.

This application is related to U.S. patent application Ser. No. ______ entitled “Systems and Methods for Operating an Interactive Repair Facility Including Repair Task Assignment,” by Carolyn Coquillette et al., Attorney Docket No. SHOP-0001-08C01US, filed Oct. 12, 2020.

### BACKGROUND

Repair shops operate with many different individuals responsible for different tasks that occur at different times beginning when a repair customer arrives at the repair shop and through every following step of what is often a very complex and involved process of diagnosis and repair. These steps include, but are not limited to: working with the customers to understand the complaint; educating them on what to expect; gaining their approval for work; diagnostic investigations; estimating the price of needed repairs; procurement of parts; etc. Traditionally, the interactions between the large number of staff necessary to accomplish these tasks has been entirely human-powered, facilitated by physical worksheets and in-person communication.

Communication between staff in a repair shop, and between shop staff and repair customers, is central to successful repair transactions. This communication is usually verbal and either in person or by telephone, and is engaged in for several reasons, including giving or requesting status of repairs, communicating discovery of new information about an ongoing repair, and asking for approval to commence a repair with financial consequence, which is required by government regulations.

Managing parts inventory is a challenge for repair shops because the parts catalog for all possible vehicles needing service is so vast and because the parts needed on any given day is inherently unpredictable. Repair shops thus employ a hybrid model of carrying some parts inventory but also rely on just-in-time parts ordering and delivery.

A critical component of every repair transaction conducted in a repair shop is identifying the initial service required for the customer and then pricing that service. Repair shops will often develop a menu of services and a set of inspection checklists. Most shops must rely on published labor time guides to price repairs based on labor time and part requirements, and they price individual repairs for every single transaction.

Repair shops make money two primary ways: 1) they mark-up the labor billed by their staff, and 2) they mark-up the prices of parts sold for repairs. Repair shops have developed many approaches to managing the second method of making money centered on finding the right markup for parts in an environment where part prices tend to be unpredictable and vary from several dollars to many thousands of dollars. These markups are organized around attempting to achieve a certain gross profit for the repair shop business in general.

### SUMMARY

In various embodiments, systems and processes are provided for operating a repair facility that is both user-interactive and customer-interactive. Tasks are offered to shop users who accept or decline, and task status is continually monitored interactively by the system and by customers. Diagnostic results and task modifications are communicated electronically to customers including high priority alerts where a response/authorization is needed quickly to avoid work stoppage. Required parts are ordered automatically based on scheduled tasks. For some embodiments, parts pricing may be based on any of: a customer's urgency and willingness to pay; historical data for the parts quantities sold; parts costs and prices charged; and profit earned. A historical database is maintained for different tasks and is accessed to provide time and/or cost estimates either solely or in conjunction with industry standard “book” data. Task data can be established over multiple regions by deploying the system in shops at diverse geographical locations.

In various embodiments, a system can include a computer system or cloud interface located in a repair facility and a wireless network in communication with the computer system or cloud interface, a repair facility user, and the Internet. In addition, the system can include an interface to a communication system in communication with the computer system or cloud interface. The system can also include a database for storing historical task-related data. Note that an expediter function offers a task assignment to a repair facility user. The repair facility user may either accept, decline, or conditionally accept the offered task. Furthermore, a status for the task is monitored once assigned. When the task status includes a time element, an alert is sent to an administrator.

In various embodiments, the system can be implemented as described in the above paragraph, wherein a task related to a job may be transferred from one repair facility user to another.

In various embodiments, the system can be implemented as described in the above paragraph, wherein a transferred task includes a notes feed related to the job.

In various embodiments, the system can be implemented as described in the third paragraph above, wherein the system directly communicates with a computing device during operation of the system and the expeditor function. The computing device is one of: a diagnostic scan tool; an alignment rack and diagnostic lift; a diagnostics telematics device; a digital camera; a smart phone; a sticker machine; and a physical time clock.

In various embodiments, a system can include a computer system or cloud interface located in a repair facility and a wireless network in communication with the computer system or cloud interface, a repair facility user, and the Internet. Furthermore, the system can include an interface to a communication system in communication with the computer system or cloud interface and a database for storing historical task-related data. It is noted that an approval function provides a repair quote to a customer including an estimated time to completion. The repair quote is transmitted remotely to the customer via the communication system or the Internet. The customer can approve, disapprove, or question the repair quote remotely.

In various embodiments, the system can be implemented as described in the above paragraph, wherein while a repair is in progress, additional tasks or parts are required or a task is determined to require more time than originally allocated. A revised repair quote is transmitted remotely to the customer and the customer can approve, disapprove, or question the revised repair quote remotely.

In various embodiments, the system can be implemented as described in the second paragraph above, wherein the repair quote transmitted to the customer includes at least a first quote and a second quote. The first quote includes a first price and a first completion time and the second quote comprises a second price and a second completion time. The customer remotely selects either the first quote or the second quote.

In various embodiments, the system can be implemented as described in the third paragraph above, wherein the system directly communicates with a computing device during operation of the system and the approval function. The computing device is one of: a diagnostic scan tool; an alignment rack and diagnostic lift; a diagnostics telematics device; a digital camera; a smart phone; a sticker machine; and a physical time clock.

In various embodiments, a system can include a computer system or cloud interface located in a repair facility and a wireless network in communication with the computer system or cloud interface, a repair facility user, and the Internet. Moreover, the system can include a database for storing historical task-related data and parts inventory data. Note that a function of the system associates individual part quantities from stock to a repair order and tracks the status and quantity of those parts for a repair facility user, thereby creating a link between parts order quantity, parts stock quantity, and parts status for each repair order.

In various embodiments, the system can be implemented as described in the above paragraph, wherein parts are automatically ordered when predicted to be needed for a job where the parts are not currently available in inventory.

In various embodiments, the system can be implemented as described in the second paragraph above, wherein the function prompts vendors of parts or outside services for updates on availability and scheduling. Those updates are incorporated into scheduling and task assignment relative to a repair order.

In various embodiments, the system can be implemented as described in the third paragraph above, wherein the system directly communicates with a computing device during operation of the system and the function. The computing device is one of: a diagnostic scan tool; an alignment rack and diagnostic lift; a diagnostics telematics device; a digital camera; a smart phone; a sticker machine; and a physical time clock.

In various embodiments, a system can include a computer system or cloud interface located in a repair facility and a wireless network in communication with the computer system or cloud interface, a repair facility user, and the Internet. Additionally, the system can include a database for storing historical task-related data and parts inventory data. Note that for a service operation and estimated parts replacement, a service builder function predicts time and cost for the service operation. The time and cost prediction is based on one of: a job template for the specific service operation; historical data for past services performed at the repair facility; estimated services based on third party data; and maintenance estimates based on third party data.

In various embodiments, the system can be implemented as described in the above paragraph, wherein the system is installed at a plurality of repair facilities, and the historical database includes service and parts data that are exported anonymously to a central location, and then analyzed to provide a frequently updated model for specific service operations.

In various embodiments, the system can be implemented as described in the above paragraph, wherein the model is adjusted for regional variances over the plurality of repair facilities.

In various embodiments, the system can be implemented as described in the third paragraph above, wherein the system actively captures shop user actions when a service is selected, created, authored, or applied. In addition, the system learns new metadata attributes for each service authored by users. Also, the system indexes the learned metadata for use by all users.

In various embodiments, the system can be implemented as described in the fourth paragraph above, wherein the system is installed at a plurality of repair facilities including a franchise operation or business owner. The franchise operation or business owner, operating as a master administrator, causes each of the plurality of repair facilities to use a central set of services curated by the master administrator.

In various embodiments, the system can be implemented as described in the above paragraph, wherein the set of curated services includes control over one of: a service menu for each of the plurality of repair facilities; pricing and quality for each of the plurality of repair facilities; inspection checklists for each of the plurality of repair facilities; and operational processes for each of the plurality of repair facilities.

In various embodiments, the system can be implemented as described in the sixth paragraph above, wherein the system directly communicates with a computing device during operation of the system and the service builder function. The computing device is one of: a diagnostic scan tool; an alignment rack and diagnostic lift; a diagnostics telematics device; a digital camera; a smart phone; a sticker machine; and a physical time clock.

In various embodiments, a system can include a computer system or cloud interface located in a repair facility and a wireless network in communication with the computer system or cloud interface, a repair facility user, and the Internet. In addition, the system can include a database for storing historical task-related data and parts inventory data. It is noted that a price matrix function learns from the repair facility's historical parts sales data, including: parts quantities sold; parts costs when sold; prices charged for the parts; and profit earned on the parts sold. The price matrix function calculates and suggests an optimal price to charge for every part at the time of estimate and the time of sale, to achieve a target gross profit.

In various embodiments, the system can be implemented as described in the above paragraph, wherein prices are determined by an automatic curve fitting process controlled by a free parameter variable assigned by a repair facility user.

In various embodiments, the system can be implemented as described in the second paragraph above, wherein the system directly communicates with a computing device during operation of the system and the price matrix function. The computing device is one of: a diagnostic scan tool; an alignment rack and diagnostic lift; a diagnostics telematics device; a digital camera; a smart phone; a sticker machine; and a physical time clock.

While various embodiments in accordance with the present disclosure have been specifically described within this Summary, it is noted that the claimed subject matter are not limited in any way by these various embodiments.

### BRIEF DESCRIPTION OF THE DRAWINGS

Within the accompanying drawings, various embodiments in accordance with the present disclosure are illustrated by way of example and not by way of limitation. It is noted that like reference numerals denote similar elements throughout the drawings.

FIG. 1 shows an overview of an exemplary system in accordance with various embodiments of the present disclosure.

FIG. 2 shows a flow chart of an exemplary repair process in accordance with various embodiments of the present disclosure.

FIG. 3 shows a user interface (UI) example of a technician being assigned a new task in accordance with various embodiments of the present disclosure.

FIG. 4 shows a UI example of a customer being asked to approve a revised quote in accordance with various embodiments of the present disclosure.

FIG. 5 shows a UI example of a customer being given a choice of quotes from which to approve one in accordance with various embodiments of the present disclosure.

FIGS. 6a-d show the results of methods for automated curve fitting for part pricing in accordance with various embodiments of the present disclosure.

FIG. 7 is a block diagram of an example of a computing system upon which one or more various embodiments described herein may be implemented in accordance with various embodiments of the present disclosure.

### DETAILED DESCRIPTION

Reference will now be made in detail to various embodiments in accordance with the present disclosure, examples of which are illustrated in the accompanying drawings. While described in conjunction with various embodiments, it will be understood that these various embodiments are not intended to limit the present disclosure. On the contrary, the present disclosure is intended to cover alternatives, modifications and equivalents, which may be included within the scope of the present disclosure as construed according to the Claims. Furthermore, in the following detailed description of various embodiments in accordance with the present disclosure, numerous specific details are set forth in order to provide a thorough understanding of the present disclosure. However, it will be evident to one of ordinary skill in the art that the present disclosure may be practiced without these specific details or with equivalents thereof. In other instances, well known methods, procedures, components, and circuits have not been described in detail as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computing system. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “implementing,” “inputting,” “operating,” “assembling,” “analyzing,” “determining,” “identifying,” “classifying,” “generating,” “extracting,” “receiving,” “processing,” “acquiring,” “performing,” “producing,” “providing,” “prioritizing,” “arranging,” “matching,” “formatting,” “communicating,” “storing,” “weighting,” “proposing,” “altering,” “creating,” “computing,” “loading” or the like, refer to actions and processes of a computing system or similar electronic computing device or processor. The computing system or similar electronic computing device manipulates and transforms data represented as physical (electronic) quantities within the computing system memories, registers or other such information storage, transmission or display devices.

Portions of the detailed description that follow are presented and discussed in terms of one or more methods. Although steps and sequencing thereof are disclosed in figures herein describing the operations of the one or more methods, such steps and sequencing are exemplary. Any method is well suited to performing various other steps or variations of the steps recited and/or shown herein, and in a sequence other than that depicted and/or described herein.

Various embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer storage media and communication media. Generally, program modules include routines, programs, objects, components, data structures, etc., that perform particular tasks or implement particular abstract data types. The functionality of the program modules may be combined or distributed as desired in various embodiments.

Computer storage media includes, but is not limited to, volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody, but is not limited to, computer-executable instructions, data structures, and program modules, and includes any information delivery media. By way of example, and not limitation, communication media includes wired media such as a wired network or direct-wired connection, and wireless media such as acoustic, radio frequency (RF), infrared (IR) and other wireless media. Combinations of any of the above can also be included within the scope of computer-readable media.

In various embodiments, systems and processes are provided for operating a repair facility that is both user-interactive and customer-interactive. Tasks are offered to shop users who accept or decline, and task status is continually monitored interactively by the system and by customers. Diagnostic results and task modifications are communicated electronically to customers including high priority alerts where a response/authorization is needed quickly to avoid work stoppage. Required parts are ordered automatically based on scheduled tasks. For some embodiments, parts pricing may be based on any of: a customer's urgency and willingness to pay; historical data for the parts quantities sold; parts costs and prices charged; and profit earned. A historical database is maintained for different tasks and is accessed to provide time and/or cost estimates either solely or in conjunction with industry standard “book” data. Task data can be established over multiple regions by deploying the system in shops at diverse geographical locations.

The following can be different user types in accordance with various embodiments of the present disclosure. For example, a technician can be a basic shop user. The technician can be the most common user who primarily accesses an application in accordance with various embodiments to perform estimates and to add notations about jobs and work. Also the technician passes work with notes to other users in the shop. The technician may or may not order parts. The technician can be restricted from some functions of a user interface in accordance with various embodiments.

Another user type in accordance with various embodiments is a shop foreman who has a role that is similar to a shop owner or administrator, but in practice may not be allowed some financial/reporting access. Yet another user type in accordance with various embodiments is a service advisor who is a basic shop user. The service advisor can be a user who is responsible for communication with customers and coordinating work with the technician users. The service advisor users will create estimates, enter notes, and interact with customer user through notes. They also manage the workflow and interact with other users on job transfers. The service advisor may or may not order parts. The service advisor can be restricted from some functions of a user interface in accordance with various embodiments.

Still another user type in accordance with various embodiments is a parts manager who is a basic shop user. The parts manager can be responsible for parts ordering and parts inventory management. The parts manager may have access to features not available to other shop users. The parts manager can be restricted from some functions of a user interface in accordance with various embodiments. Another user type in accordance with various embodiments is a shop owner/administrator. The shop owner/administrator can have all of the access and capabilities of other shop users. Also the shop owner/administrator has the ability to create other users, change shop configuration settings (such as labor rates), can order parts, can manage workflow and transfer jobs, and can access all reporting functions.

Yet another user type in accordance with various embodiments is a customer user, or just “customer.” A customer does not have a shop user “account” with the system in accordance with various embodiments, but has instead a Customer Account. Customers are recognized and recorded by the software when they interact with a system in accordance with various embodiments. Customers can interact with the notes feed where allowed. Customer users can log in and view their service history for their vehicle(s), and can view progress and estimates for a job in progress.

### The Expeditor—Interactively Controlling Jobs in the Shop

In various embodiments, the Expeditor function introduces a solution that exploits multi-user interactivity such that actions and notifications are taken and delivered by the function to replace the current human and paper-centered methodology. Users transfer tasks using the Expeditor to other shop users, and ask questions or make requests that are recorded by the Expeditor. The time lapsed before users accept or do not accept tasks give management the ability to track the status of urgent work without human intervention. The Expeditor completely changes the internal operations of a repair shop, including the physical appearance by eliminating printers, clipboards, and paper, and in the activities of the staff, who engage in communication with one another on work tasks in an entirely new way.

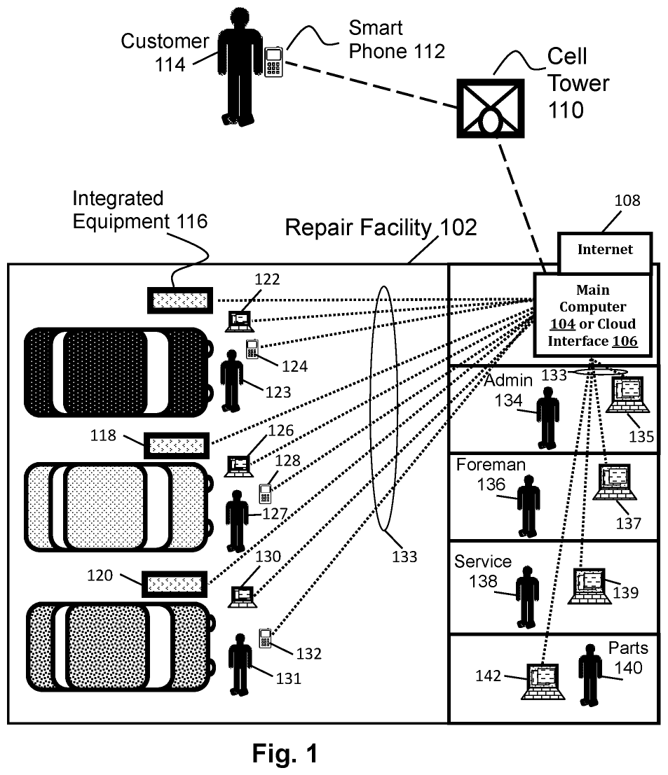

A generalized and exemplary overview diagram of a repair shop 102 operated in accordance with various embodiments of the present disclosure is shown in FIG. 1. Here, a resident main computer system 104 is located within an exemplary repair facility 102 and/or a cloud interface 106 is established among the various workstations and smart phones involved, with controlling software running on servers in the Cloud. At each technician workstation there is at least a personal computer (PC) (e.g., 122, 126, or 130) or smart phone (e.g., 124, 128, or 132) and where appropriate also integrated equipment (e.g., 116, 118, or 120) that communicates through the local network 133 with the main computer 104 or cloud interface 106. The main computer 104 or cloud interface 106 also communicates through a cellular link 110 with customers (e.g., 114) via a smart phone 112 outside the repair facility 102, as well as shop users who may during some activities be physically located outside the physical repair facility 102. Customers (e.g., 114) may also communicate with the system via the Internet 108 using a web interface provided by the system.

As shown in FIG. 1, the repair facility 102 can include, but is not limited to, technicians 123, 127, and 131. In addition, the repair facility 102 can include, but is not limited to, a shop owner/administrator 134 that has a computer 135, a shop foreman 136 that has a computer 137, a service advisor 138 that has a computer 139, and a parts manager 140 that has a computer 142. It is noted that the computers 135, 137, 139, and 142 can communicate through the local network 133 with the main computer 104 or cloud interface 106.

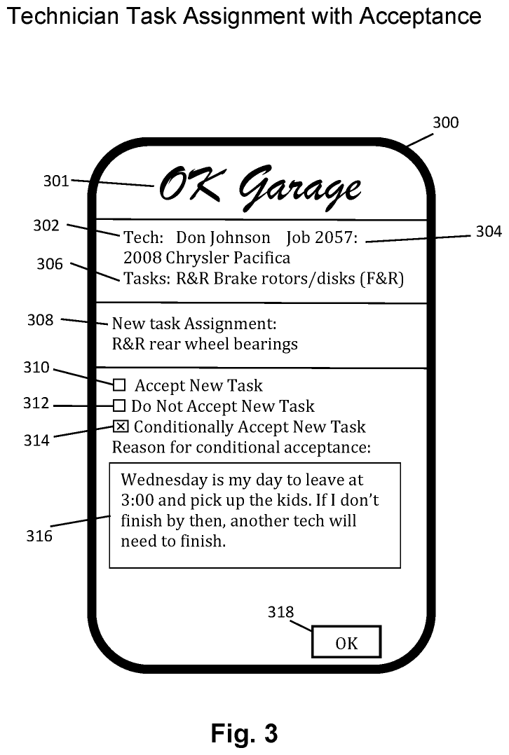

In various embodiments, the Expeditor function handles task detail and employee ownership of tasks as well as a state of those tasks. The Expeditor enables “dispatching” of assigned tasks through system software to shop users. The Expeditor enables accepting, not accepting, or conditionally accepting, tasks by shop users as shown in FIG. 3.

In various embodiments, not accepting a task can take a number of forms. The system can accept pre-recorded reasons as well as free-form notes that are recorded. Not accepting can also be due to a physical limitation, a lack of a specific skill, a personal time commitment (e.g., doctor appointment, picking the kids up at school, etc.). An example of a conditional task acceptance includes: “I accept this only if I finish task X in Y hours. If not, I won't have time to complete it, and someone else would need to take over that task.” It's also possible that a person might accept the first portion of a job thereby finishing a portion of the tasks, and then set up the remaining tasks to be finished by another person.

FIG. 3 shows a user interface (UI) 300 example of a technician being assigned a new task in accordance with various embodiments of the present disclosure. The user interface 300 can include a repair facility identifier 301 (e.g., name), a technician identifier 302 (e.g., name), a job identifier 304 (e.g., year, make, and model of vehicle), a tasks identifier 306, and a new task assignment identifier 308. In addition, the user interface 300 can include a selection area 310 enabling the technician to accept the new task, a selection area 312 enabling the technician to not accept the new task, and a selection area 314 enabling the technician to conditionally accept the new task. The user interface 300 can also include a comment area 316 enabling the technician to provide one or more reasons for the conditional acceptance of the new task. Furthermore, the user interface 300 can include an OK area or “button” 318 for the technician to select when done with the user interface 300.

In various embodiments, the Expeditor function tracks wait times of tasks and displays these as part of various statistics (stats) defined by Administrators to allow shop users (e.g., technicians, parts manager, service advisors, checkout) to manage task age and expedite task completion. Alerts are generated to signal critical situations that could delay completing of one or more jobs. In various embodiments, at least three priorities would typically be utilized for alerts: Urgent (must be looked at now); Normal (for today); Low (after all current work is complete). These alerts can be structured to apply to different roles, for example, Service Advisor, Parts Manager, and Technician.

When the system in accordance with various embodiments of the present disclosure needs to alert an administrator to a critical situation that has developed with respect to one or more jobs, a text message alert can be sent to the administrator—sent from a central phone number such that the administrator's phone can be set up with a specific tone to alert them to such critical messages.

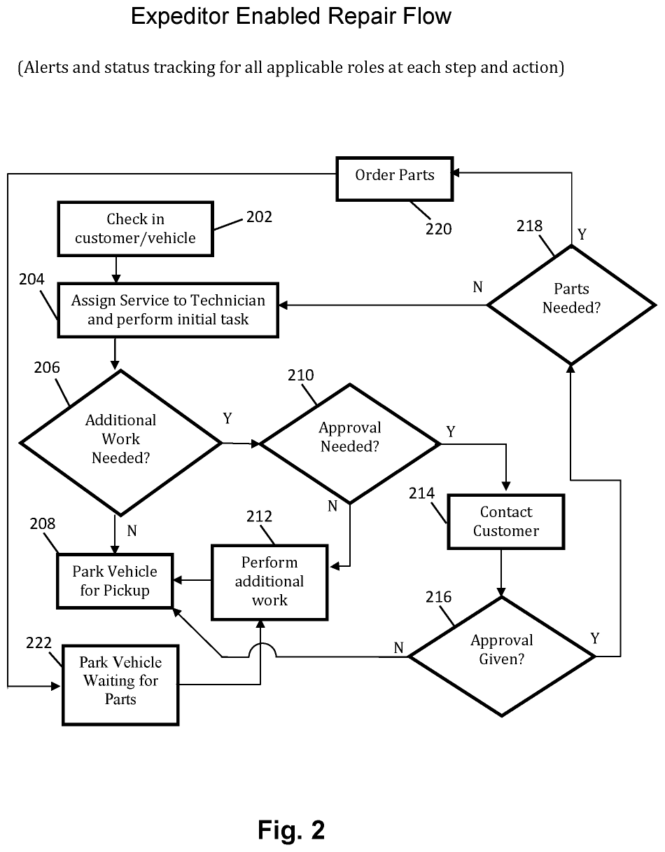

A generalized flow diagram for activities at a repair facility operated in accordance with various embodiments is shown in FIG. 2. Note that FIG. 2 shows Expeditor enabled repair flow. The Expeditor can provide alerts and status tracking for all applicable roles at each step and action.

At operation 202, check in the customer/vehicle. Note that operation 202 can be performed in any manner similar to that described and/or shown by the present disclosure, but is not limited to such.

At operation 204 of FIG. 2, assign service to a technician and perform the initial task. It is noted that that operation 204 can be performed in any manner similar to that described and/or shown by the present disclosure, but is not limited to such.

At operation 206, determine if additional work is needed. If not, proceed to operation 208. However, if it is determined at operation 206 that additional work is needed, proceed to operation 210. Note that operation 206 can be performed in any manner similar to that described and/or shown by the present disclosure, but is not limited to such.

At operation 208 of FIG. 2, park vehicle for pickup. It is noted that that operation 208 can be performed in any manner similar to that described and/or shown by the present disclosure, but is not limited to such.

At operation 210, determine if approval is needed for the additional work. If not, proceed to operation 212. However, if it is determined at operation 210 that approval is needed for the additional work, proceed to operation 214. Note that operation 210 can be performed in any manner similar to that described and/or shown by the present disclosure, but is not limited to such.

At operation 212 of FIG. 2, perform additional work. After operation 212, proceed to operation 208. It is noted that that operation 212 can be performed in any manner similar to that described and/or shown by the present disclosure, but is not limited to such.

At operation 214, contact customer regarding approval of the additional work. Note that operation 214 can be performed in any manner similar to that described and/or shown by the present disclosure, but is not limited to such.

At operation 216 of FIG. 2, determine if approval is given for the additional work. If not, proceed to operation 208. However, if it is determined at operation 216 that approval has been given for the additional work, proceed to operation 218. It is noted that that operation 216 can be performed in any manner similar to that described and/or shown by the present disclosure, but is not limited to such.

At operation 218, determine if parts are needed for the additional work. If not, proceed to operation 204. However, if it is determined at operation 218 that parts are needed for the additional work, proceed to operation 220. Note that operation 218 can be performed in any manner similar to that described and/or shown by the present disclosure, but is not limited to such.

At operation 220 of FIG. 2, order parts needed for the additional work. It is noted that that operation 220 can be performed in any manner similar to that described and/or shown by the present disclosure, but is not limited to such.

At operation 222, park vehicle waiting for parts for the additional work. After operation 222, proceed to operation 212. Note that operation 222 can be performed in any manner similar to that described and/or shown by the present disclosure, but is not limited to such.

Job Communication, Recommendation, and Interactive Customer Approval

Various embodiments in accordance with the present disclosure facilitate communication among repair shop staff and with repair customers around individual repair transactions. Various embodiments include the ability to capture and communicate rich media and to interface with physical mobile devices during the repair work. Various embodiments specifically allow repair staff to make encapsulated repair recommendations to customers based on staff findings during a repair, and allow repair customers to give approval directly via electronic means, in addition to traditional means, and record each outcome and the method employed.

Various embodiments in accordance with the present disclosure give repair shops the operational capability to eliminate phone calls to customers, which are a cost center for their business. Various embodiments also give them the ability to document and record the reasoning for the work they recommend, including photos and diagnostic technical information which support their reasoning and justify their pricing.

When integrated into the overall system in accordance with various embodiments of the present disclosure, several functions are facilitated. A tool known as the “notes feed” is available in the user interface (UI) screen for a repair order, or “job.” The notes feed allows a shop user to capture long-hand notes about a job to be performed on a vehicle, included what a customer says about a problem, or tasks to be accomplished. The notes feed allows the attachment and sharing of electronic documents including photos among shop users. The notes feed also allows a user to share—over web-enabled communication including email and text—a link to the repair order or job, and asynchronously communicate with customers about that repair order or job.

In various embodiments, the notes feed allows a shop user to build a formal structured recommendation for additional work to be performed, including the reason for the work, an estimate of the time required to perform the work, and the cost of the work. That structured recommendation is then shared with and reviewed by the customer asynchronously over an electronic communication link. The customer may use a web browser interface to accomplish this or alternately an app (application) on a smart phone, or even communicate using text messages.

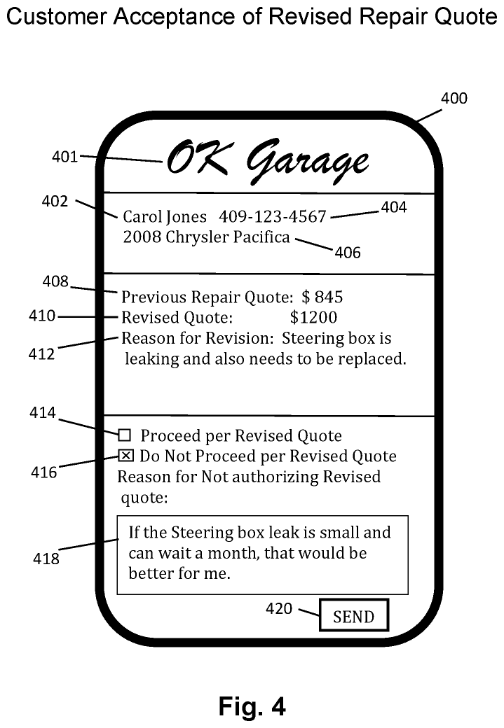

In various embodiments, the notes feed allows customers to interactively review recommendations and approve, disapprove, or further question an estimate for additional work and estimates, and the system documents the approvals and details on the repair order. An exemplary user interface for such a function as operated on a smart phone in accordance with various embodiments is shown in FIG. 4. Note that by facilitating a quick response by the customer, workflow is improved and stoppages are prevented. A history of response times by each customer provides future projections of response times such that workflow can be more accurately planned. Text messages from the repair facility to the customer come from a central phone number such that the customer's phone can be set up with a specific tone to alert them to messages from the repair facility.

FIG. 4 shows a user interface (UI) 400 example of a customer being asked to approve a revised quote in accordance with various embodiments of the present disclosure. The user interface 400 can include a repair facility identifier 401 (e.g., name), a customer identifier 402 (e.g., name), a customer's contact number 404 (e.g., phone number), a customer's vehicle identifier 406 (e.g., year, make, and model of vehicle). Additionally, the user interface 400 can include the previous repair quote 408, a revised quote 410, and a reason for the revision 412. Furthermore, the user interface 400 can include a selection area 414 enabling the customer to approve proceeding per the revised quote and a selection area 416 enabling the customer to not approve proceeding per the revised quote. Moreover, the user interface 400 can include a comment area 418 enabling the customer to provide one or more reasons for not authorizing the revised quote. The user interface 400 can also include a SEND area or “button” 420 that the customer can select to send the information of the user interface 400 to the repair facility.

In various embodiments, in addition to interaction with customers, the system can interact with vendors/suppliers. The notes feed functionality can be expanded to include interaction with vendors for information and updates on the parts that are on a repair order, rather than through the technician, service advisor, or parts manager. The system can prompt vendors via a shop text address or email (electronic mail) address for information, and could post replies/responses to the notes feed to provide more current information on parts status.

Parts Inventory and Supply Management

Various embodiments in accordance with the present disclosure improve a repair shop's ability to manage its inventory, and especially its just-in-time inventory needs, by linking parts tracked as part of inventory stock to individual repair orders and the status of both the repair order and a part order. As parts are ordered to complete individual repairs, the status of the repair and the status of the part are made available to relevant staff members, regardless of who placed the part order, including automatic part orders. In some cases, a repair may be on hold waiting for the part, and timely status and accurate predictions of arrival times is critical to tightly manage overall job workflow.

In various embodiments, downstream when parts are received, the status of the repair is changed and staff are alerted. In various embodiments, this system of alerts and statuses introduces new efficiency to a repair shop, where any association between parts on a truck or on shelves, and repairs to be done, is today linked only by a human process and knowledge.

This function in accordance with various embodiments tracks part item stock inventory levels. Repair facilities stock commonly used and sold parts and also order special items to fulfill the needs of a given job on a given day. In various embodiments, the function facilitates the creation of purchase orders for stock refills, and also tracks the status of parts in stock as “needed,” “on order,” or “on hand.”

In various embodiments, the function associates individual part quantities from stock with individual repair orders or “jobs”, and tracks the status and quantity of those parts for the shop user, creating links between: parts order quantity; parts stock quantity; and parts status down to the individual repair.

In various embodiments, this parts ordering and tracking capability at the repair order level, as enabled and linked, enables parts to be ordered automatically without need for human intervention within a parts department. In that case, a parts Administrator may oversee this automatic functionality as opposed to manually performing each parts ordering operation.

In cases where the estimated delivery time for a part is available to the system in various embodiments, the system will record that estimated delivery time so that job completion planning is possible. This tracking parts order status at the level of the individual report order, means the system in various embodiments gives technician and parts manager users a clear view of when a part will arrive and an individual, part-dependent job can be completed. The system's ability to track inventory more easily, and to recommend re-order, is the primary enabler for avoiding delays in getting parts. Also, the system has the ability to build and share an estimate in advance of the vehicle arriving for work. To do so, the system uses problem descriptions supplied by the customer as well as vehicle information to build a service estimate using the Service Builder application, and shares that estimate with the customer using messaging/notes feed. The customer can approve the work in advance. The system also determines in advance whether a part is inventory or not, whether it needs to be ordered or not, and whether it will be available on the date of the receiving the vehicle for service.

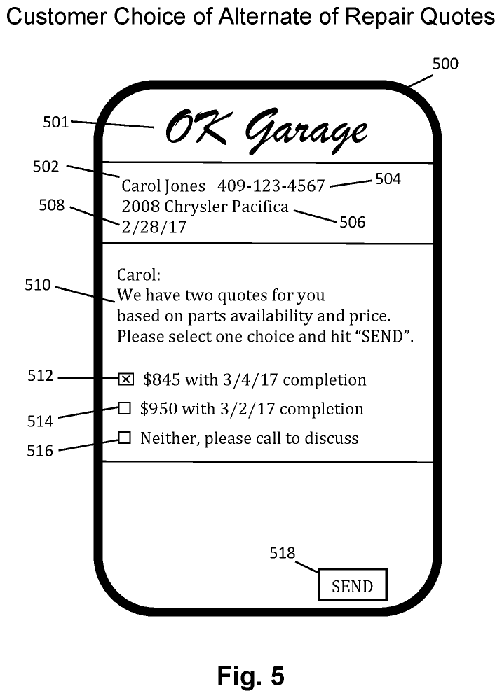

In some cases, the cost of a part may vary with the source and the delivery time. As such, for one embodiment of the present disclosure a cost quoted to a customer provides choices based on the customer's urgency and willingness to pay. In other words, a customer might be given two choices: “You can have the car back Wednesday for X dollars, or alternately you can have it Tuesday for Y dollars if we choose a more expensive part”. Then the customer can interactively authorize one of the choices as shown for example in FIG. 5 in accordance with various embodiments. In another embodiment, the system can offer a first ordering option based on profitability of the part, and then a second ordering option based on availability of the part.

FIG. 5 shows a user interface (UI) 500 example of a customer being given a choice of quotes from which to approve one in accordance with various embodiments of the present disclosure. The user interface 500 can include a repair facility identifier 501 (e.g., name), a customer identifier 502 (e.g., name), a customer's contact number 504 (e.g., phone number), a customer's vehicle identifier 506 (e.g., year, make, and model of vehicle), and the date 508. In addition, the user interface 500 can include a message 510 to the customer regarding the choice of quotes. The user interface 500 can also include a selection area 512 enabling the customer to approve a lower repair quote with a later completion date, a selection area 514 enabling the customer to approve a higher repair quote with a sooner completion date, and a selection area 516 enabling the customer to choose neither quote and request a call from the repair facility. Furthermore, the user interface 500 can include a SEND area or “button” 518 that the customer can select to send the information of the user interface 500 to the repair facility.

### Service Builder and Service Application

Various embodiments in accordance with the present disclosure utilize patterns of repairs and include the ability of the system to discover and store metadata as users interact with the system to learn from patterns of pricing services in a repair shop. Examples of such metadata include: Year; Make; Model; Engine; and Service name, e.g., “brake,” “transmission,” etc.

In various embodiments, the system then utilizes this historical data to predict pricing for services and reduce the time required to complete service building and pricing tasks. Each day as services are built and priced in a repair shop, various embodiments in accordance with the present disclosure rapidly builds a database base of valuable information for that shop, and makes it readily available to shop users. This creates efficiencies for the repair shop, as staff members spend less time on repetitive tasks and more time on less repetitive tasks. Additionally, this function in various embodiments provides less variation in services and pricing, which is beneficial for business controls.

In various embodiments, the system utilizes search/indexing/filtering methods to give shop users access to a database of services of different types: a canned job (a job template), past services, estimated services based on 3rd party data, and maintenance estimates based on 3rd party data. The system searches the database using filtering on metadata to match services with vehicle configurations. Note that not all services match all vehicle configurations.

In various embodiments, the system actively captures shop user actions when a service is selected, created, authored, or applied, “learns” new metadata attributes for each service authored by users, and indexes that data for use by all users going forward. An example of acquiring new metadata and the associated learning process follows: a job is performed for a 2006 Honda Odyssey; two weeks later a 2010 Honda Odyssey comes to the shop; a shop user finds the 2006 Honda Odyssey job using the metadata/search; data from servicing the 2006 Odyssey is used with modification and/or addition to service the 2010 Honda Odyssey; and the system captures the 2010 Odyssey metadata addition for use in the future.

A broader use of the Service Builder functionality includes the scenario where the system according to various embodiments has been installed at a wide variety of repair facilities in different geographic locations, and service history data from those locations is exported anonymously to a central location. That data is then analyzed to provide a “living” version of the ubiquitous “Repair Book”, available historically from companies like Chilton, Motor, and Mitchell.

Also, in the case of multi-location operations, particularly larger franchises, the system in various embodiments affords the franchise or business owner (e.g., administrator or master administrator) to force individual locations to use a central set of services curated by the master administrator. This affords control over the service menu and also over pricing and quality, as well as inspection checklists and processes in the shop.

Automated Parts Price Matrix

Various embodiments in accordance with the present disclosure solve the problem of hitting a desired parts profit target in an environment of significant parts price variance and parts sales velocity. Using a process for assessing a repair shop's historical parts sales data, the system in various embodiments learns optimal markups for any given part and also adjusts to: fluctuations in underlying part prices; changes in the sales velocity of any given part; and the overall gross profit performance of the parts portfolio in a given time period.

Auto repair shops charge a markup on the cost of parts and attempt to achieve a certain gross profit across all parts sales. Traditionally, auto repair shops have guessed at this markup, or have applied a “matrix” that gives different markup rates for different part types in an attempt to optimize to a gross profit outcome.

Various embodiments in accordance with the present disclosure replace a human-powered estimate of how to reach a target profit objective, and uses predictive processes to accurately fit pricing models to a specified profit target. The system in various embodiments employs proprietary processes that learn from a repair shop's historical parts sales data, including the parts quantities sold, the parts costs when sold, and the prices charged, and the profit earned on those parts to calculate and suggest an optimal price to charge for every part at the time of estimate and sale to achieve a target gross profit each month.

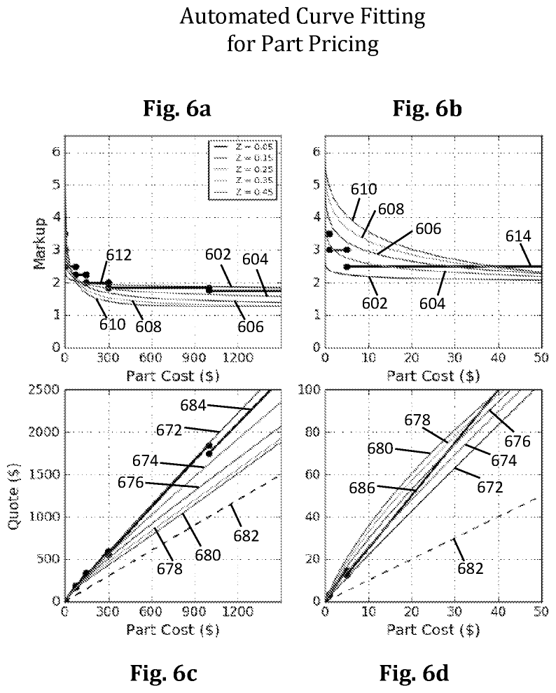

Pricing results of Automatic Curve Fitting processes according to various embodiments are shown in FIGS. 6a, 6b, 6c, and 6d. In various embodiments, an automated best fit process chooses a markup curve based on user inputs. A free parameter (Z) is available to control how fast the markup curve should drop off from the maximum markup as part cost increases. The plots shown in FIGS. 6a-6d describe the results of an automated curve fitting operation using different starting constraints, and how the value of parameter Z influences a pricing curve shape. A good starting point for Z may be 1/(maxMarkup), but finer control may be desired. Black lines (e.g., 612 of FIG. 6a, 614 of FIG. 6b, 684 of FIGS. 6c, and 686 of FIG. 6d) in each plot show values suggested by a generic price matrix, such as for example: (http://www.ratchetandwrench.com/RatchetWrench/November-2015/Building-a-Parts-Matrix/).

Subplots include: FIG. 6a shows a suggested markup as a function of part price. FIG. 6b shows a zoomed in version of FIG. 6a, focused on $0-$50 range. FIG. 6c shows a suggested part quote vs. part cost. Note that the dashed line 682 shows quote=cost, for reference. FIG. 6d shows a zoomed in version of FIG. 6c, focused on $0-$50 range.

Within FIGS. 6a and 6b, note that curve 602 is associated with Z=0.05, curve 604 is associated with Z=0.15, curve 606 is associated with Z=0.25, curve 608 is associated with Z=0.35, and curve 610 is associated with Z=0.45. In addition, within FIGS. 6c and 6d, note that curve 672 is associated with Z=0.05, curve 674 is associated with Z=0.15, curve 676 is associated with Z=0.25, curve 678 is associated with Z=0.35, and curve 680 is associated with Z=0.45.

### Data Replay

Additionally, in various embodiments, past sales data is used to simulate how well target Gross Profit would have been attained using model-suggested markups. In simulations, the model fits a curve to the previous month's sales data based on the user's inputs. The model-suggested markup is then applied to all of the parts sold in the next month, and the corresponding Gross Profit is calculated. The process repeats for each month of available sales data, with the markup curve being recalculated each month based on the previous month's sales.

In various embodiments, alternate ways of recalculating this curve are, for instance: using all previous sales, rather than only the previous month; recalculating the curve on a daily basis using sales from the previous 30 days; using sales from the same month, a year before (e.g., predict for November 2016 using November 2015 data). This would be useful if parts sales distributions show seasonal trends.

Integration with Physical Machines

The following is a list of physical apparatus that are coupled to a system in accordance with various embodiments of the present disclosure.

Smart Phone photo direct loading—In various embodiments the system exploits the native camera in all smart phones to allow taking of pictures and attachment of pictures in the Notes Feed to be used in communication with customers and other shop users. Smart Phone and Computer talk-to-type (speech recognition) is utilized to enable talk-to-type within text fields for entry of repair information and customer communication in the Notes Feed. When used with a headphone apparatus, technicians can describe issues related to their work while they perform that work.

Digital Camera direct loading—The system in accordance with various embodiments of the present disclosure interfaces directly with a digital camera to enable attachment of a photo to the Notes Feed for customer sharing and communication without the steps of taking a photo, saving, downloading, and uploading/attaching the photo.

“Lube” Sticker Machines—These machines are used to print a sticker with reminder information about future vehicle service intervals. In various embodiments, the system's database has the data necessary to forecast a mileage or date interval at which a vehicle should receive future maintenance service. Some examples of criteria for forecasts are, but are not limited to: Year Make Model; oil type (e.g., synthetic vs. not); manufacturer or shop recommendation for fluid change intervals, etc.; a customer's driving history and effects on a vehicle of the customer's actual style of driving; and checks of specific components based on vehicle history where in previous visits a component was deemed to be somewhat worn but not ready to be replaced. In various embodiments, the system interacts with a printer to create a physical sticker for placement in a vehicle with this information to remind a driver to return to the shop for maintenance at the correct time.

Technician time-tracking integration—Shop-Ware tracks technician time in shop and also on individual jobs. Shop-Ware can and should integrate with a physical time clock in the shop for the purpose of reinforcing the need for a technician to be present in the shop to clock in and not “game the system” in the software. These devices exist and integrate with the software through API (application programming interface). Besides integrating an actual time clock, in one embodiment the system tracks cell phones of employees to determine when they are on shop premises. For one exemplary implementation a Bluetooth enabled device adjacent each entry way to a facility synchronizes with employee phones as they walk through. In an alternative embodiment, an app on phones of shop users would prompt them to clock in upon physical entry into the shop.

On-board Diagnostics Telematics Device—Third party manufacturers have introduced wireless-enabled devices that plug into a vehicle's on-board diagnostics port and monitor, record, and report wirelessly the results reporting by a vehicle on-board computer. These “telematics” devices can relay trouble and diagnostic information to a system in accordance with various embodiments via a software interface, and the system can record and communicate this information, tied to the Vehicle and a Repair Order or Recommendation, to a shop and to a customer.

Diagnostic Scan Tool—Trouble codes taken from a vehicle diagnostic port by a physical 3rd party scan tool can be relayed to the system in various embodiments and tied to Vehicle and Repair Order via software interaction. The system can interact with trouble-code data and tie to recommended/common problems and repairs related to specific trouble-codes for the vehicle configuration. The system can communicate this information through the Notes Feed.

Alignment Rack & Diagnostic Lift—Several manufacturers of alignment equipment, some with integrated diagnostic capability such as the system manufactured by Hunter, afford the ability to integrate via software and deliver diagnostic results to a system in accordance with various embodiments of the present disclosure. Essentially, physical scans of the vehicle and measurements taken would be relayed to the Vehicle and Repair Order record within the system database in various embodiments. This information can be communicated by the system to the technician and to the customer.

### User Interface Dashboard

In various embodiments, one implementation of the user interface dashboard is available to administrators, while a variation with reduced functionality is available to shop users.

### Time Sensitive Operation

Various embodiments in accordance with the present disclosure include automated tasks and systems which frequently operate in a time-sensitive manner within, and in communication with, a repair facility. Any issue that places a repair project in jeopardy produces a high-priority alert so that responsible system administrators are immediately notified and can act quickly to mitigate potential negative effects. For one embodiment of the present disclosure, security administrators are notified by a text to their cell phone through a cellular infrastructure in order to alert them as quickly as possible. To this end, a unique audible tone is assigned for incoming texts that is specifically associated with highly critical alerts. For customer-interactive communications where a response from a customer is critical to timely repair service, the customer is also alerted, and for one embodiment is alerted by a text to their cell phone through a cellular infrastructure in order to promote a response as quickly as possible.

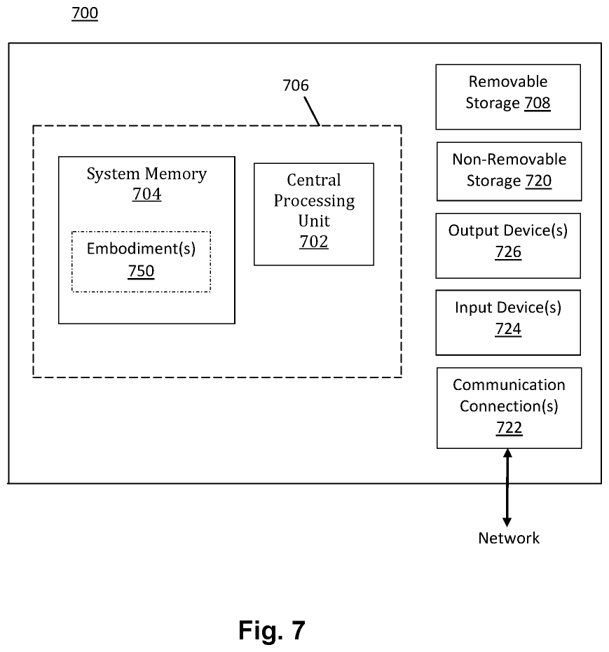

FIG. 7 shows a block diagram of an example of a computing system 700 upon which one or more various embodiments described herein may be implemented in accordance with various embodiments of the present disclosure. In a basic configuration, the system 700 includes at least one processing unit 702 and memory 704. This basic configuration is illustrated in FIG. 7 by dashed line 706. The system 700 may also have additional features and/or functionality. For example, the system 700 may also include additional storage (e.g., removable and/or non-removable) including, but not limited to, magnetic or optical disks or tape. Such additional storage is illustrated in FIG. 7 by removable storage 708 and non-removable storage 720. The system 700 may also contain communications connection(s) 722 that allow the device to communicate with other devices, e.g., in a networked environment using logical connections to one or more remote computers.

The system 700 may also includes input device(s) 724 such as a keyboard, mouse, pen, voice input device, touch input device, etc. Output device(s) 726 such as a display device, speakers, printer, etc., may also be included.

In the example of FIG. 7, the memory 704 includes computer-readable instructions, data structures, program modules, and the like associated with one or more various embodiments 750 in accordance with the present disclosure. However, the embodiment(s) 750 may instead reside in any one of the computer storage media used by the system 700, or may be distributed over some combination of the computer storage media, or may be distributed over some combination of networked computers, but are not limited to such.

It is noted that the computing system 700 may not include all of the elements illustrated by FIG. 7. In addition, the computing system 700 can be implemented to include one or more elements not illustrated by FIG. 7. It is pointed out that the computing system 700 can be utilized or implemented in any manner similar to that described and/or shown by the present disclosure, but is not limited to such.

The foregoing descriptions of various specific embodiments in accordance with the present disclosure have been presented for purposes of illustration and description. They are not intended to be exhaustive or to limit the present disclosure to the precise forms disclosed, and many modifications and variations are possible in light of the above teaching. The present disclosure is to be construed according to the Claims and their equivalents.

What is claimed is:

1. A system comprising:
a computer system or cloud interface located in a repair facility;
a network in communication with the computer system or cloud interface, and the Internet;
a database for storing historical task-related data and parts inventory data;
wherein the system learns from the repair facility's historical parts sales data, including: parts quantities sold; parts costs when sold; prices charged for the parts; and
profit earned on the parts sold; and
wherein based on the repair facility's historical parts sales data and using a price matrix function, the system calculates an optimal price to charge for one or more parts at the time of estimate or the time of sale, to achieve a target gross profit;
wherein the system provides a repair quote to a customer including an estimated time to completion, wherein the repair quote comprises the optimal price for a part associated with the repair quote;
wherein the repair quote is transmitted remotely to the customer via a communication system or the Internet;
wherein upon receiving the repair quote, the customer is alerted.

2. The system as described in claim 1, wherein prices are determined by the price matrix function using an automatic curve fitting process controlled by a free parameter variable.

3. The system as described in claim 1, wherein the target gross profit is for a defined time period.

4. The system as described in claim 2, wherein the free parameter variable controls how fast a pricing markup curve decreases from a maximum markup as part cost increases.

5. The system as described in claim 2, wherein the starting point for the free parameter variable is 1 divided by the maximum markup.

6. The system as described in claim 2, wherein a chosen value for the free parameter variable determines, at least in part, a shape of the pricing curve.

7. The system as described in claim 1, wherein past sales data is used to simulate how well target gross profit is attained using price matrix model-suggested markups.

8. The system as described in claim 7, wherein a model fits a curve to a previous time period's sales data to produce a model-suggested markup based on a repair facility user's inputs; and
wherein the price matrix model-suggested markup is then applied to some or all of the parts sold in a subsequent time period.

9. The system as described in claim 1, wherein the customer approves, disapproves, or questions the repair quote remotely.

10. The system as described in claim 1, wherein the system builds a service estimate in advance of a vehicle arriving for service work, using problem descriptions supplied by the customer and historical service information for the customer's vehicle to build the service estimate, and wherein the customer approves the service estimate in advance of the vehicle arriving for service.

11. The system as described in claim 1, wherein while a repair is in progress, an additional part is required;
wherein a revised repair quote comprising the optimal price for the additional required part is transmitted remotely to the customer;
wherein upon receiving the revised repair quote, the customer is alerted; and
wherein the customer approves, disapproves, or questions the revised repair quote remotely.

12. The system as described in claim 1, wherein while a repair is in progress, a task is determined to require more time than originally allocated;
wherein a revised repair quote is transmitted remotely to the customer;
wherein upon receiving the revised repair quote, the customer is alerted; and
wherein the customer approves, disapproves, or questions the revised repair quote remotely.

13. The system as described in claim 1, wherein the repair quote comprises a photo, diagnostic technical information, or a link to a repair order or job.

14. The system as described in claim 1, wherein the repair quote transmitted to the customer comprises at least a first quote and a second quote;
wherein the first quote comprises a first price and a first completion time;
wherein the second quote comprises a second price and a second completion time; and
wherein the customer remotely selects either the first quote or the second quote.

15. The system as described in claim 14, wherein the first price is lower than the second price and the first completion time is later than the second completion time, thus enabling the customer to obtain an earlier completion time if they choose to pay the second price.

16. The system as described in claim 1, wherein the system offers a task assignment to a repair facility user;
wherein the repair facility user accepts, declines, or conditionally accepts the offered task;
wherein the conditional acceptance is based at least in part on an estimated completion time for a predecessor task; and
wherein if the offered task is not accepted or conditionally accepted, the offered task is transferred via the system from the repair facility user to another repair facility user.

17. The system as described in claim 1, wherein the system communicates directly with one or more computing devices during operation of the system during a repair process; and
wherein at least one of the computing devices has one or more of the following capabilities to aid in documenting the repair process:
voice input;
voice recording;
speech recognition to produce a text output; and
image or video capture.

18. A method comprising:
storing via a database historical task-related data and parts inventory data of a repair facility, wherein a system comprises the database;
learning from the repair facility's historical parts sales data, including: parts quantities sold; parts costs when sold; prices charged for the parts; and profit earned on the parts sold, wherein the learning is performed by the system which further comprises a computer system or cloud interface located in the repair facility; and
calculating, based on the repair facility's historical parts sales data and using a price matrix function, an optimal price to charge for one or more parts at the time of estimate or the time of sale by the repair facility, to achieve a target gross profit, wherein the calculating is performed by the system;
transmitting a repair quote from the repair facility to a customer via a communication system, wherein the transmitting is performed by the computer system or cloud interface of the repair facility, the repair quote comprises an estimated time to completion and the optimal price for a part associated with the repair quote;
upon receiving the repair quote, alerting the customer.

19. The method as described in claim 18, further comprising:
communicating directly with one or more computing devices during operation of the system during a repair process, wherein at least one of the computing devices has one or more of the following capabilities to aid in documenting the repair process:
voice input;
voice recording;
speech recognition to produce a text output; and
image or video capture.

20. The method as described in claim 18, wherein the calculating an optimal price is determined by the price matrix function and comprises utilizing an automatic curve fitting process controlled by a free parameter variable.

21. The method as described in claim 20, wherein the free parameter variable controls how fast a pricing markup curve decreases from a maximum markup as part cost increases.

22. The method as described in claim 18, further comprising:
building, via the system, a service estimate in advance of a vehicle arriving for service work, using problem descriptions supplied by the customer and historical service information for the customer's vehicle to build the service estimate; and
receiving from the customer via the communication system an approval of the service estimate in advance of the vehicle arriving for service, wherein the receiving from the customer is performed by the computer system or cloud interface of the repair facility.

23. The method as described in claim 18, further comprising:
receiving from the customer via the communication system an approval, disapproval, or a question about the repair quote, wherein the receiving is performed by the computer system or cloud interface of the repair facility.

24. The method as described in claim 23, further comprising:
while a repair is in progress, determining an additional part is needed;
transmitting a revised repair quote from the repair facility to the customer via the communication system, wherein the transmitting is performed by the computer system or cloud interface of the repair facility, the revised repair quote comprises the optimal price for the additional part;
upon receiving the revised repair quote, alerting the customer; and
receiving from the customer via the communication system an approval, disapproval, or a question about the revised repair quote, wherein the receiving from the customer is performed by the computer system or cloud interface.

25. The method as described in claim 23, wherein the repair quote comprises a photo, diagnostic technical information, or a link to a repair order or job.

26. A system comprising:
a computer system or cloud interface located in a repair facility;
a wireless network in communication with the computer system or cloud interface, and the Internet;
a database for storing historical task-related data and parts inventory data;
wherein the system learns from the repair facility's historical parts sales data, including: parts quantities sold; parts costs when sold; prices charged for the parts; and profit earned on the parts sold;
wherein based on the repair facility's historical parts sales data and using a price matrix function, the system calculates and suggests an optimal price to charge for one or more parts at the time of estimate or the time of sale, to achieve a target gross profit;
wherein the system provides a repair quote to a customer including an estimated time to completion, wherein the repair quote comprises the optimal price for a part associated with the repair quote;
wherein the repair quote is transmitted remotely to the customer via a communication system or the Internet; and
wherein upon receiving the repair quote, the customer is alerted;
wherein the system directly communicates with a computing device during operation of the system, and the computing device tracks phones of employees to determine when they are on the repair facility premises; and
wherein at least one such computing device is wireless enabled and located adjacent an entry way to the repair facility and communicates with an employee's phone as the employee walks through the entry way.

27. The system as described in claim 26, wherein the system builds a service estimate in advance of a vehicle arriving for service work, using problem descriptions supplied by the customer and historical service information for the customer's vehicle to build the service estimate, wherein the customer approves the service estimate in advance of the vehicle arriving for service.
